(19) United States
(12) Patent Application Publication
(10) Pub. No.: US 2005/0117553 A1
(43) Pub. Date: Jun. 2, 2005

(54) Method and device for downlink packet access signaling for time division duplex (tdd) mode of a wireless communication system

(76) Inventors: Daqing Wang, Beijing (CN); Chen Yuan, Beijing (CN)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/500,790

(22) PCT Filed: Jan. 4, 2002
(86) PCT No.: PCT/EP02/00047

(51) Int. Cl. H04Q 7/24

(52) U.S. Cl. 370/338

(57) ABSTRACT

The present invention provides a method, a device and a system for High-Speed Downlink Packet Access (HSDPA) for Time Division Duplex (TDD) mode of a wireless communication system, especially of a Universal Mobile Telecommunication System (UMTS) Terrestrial Radio Access Network (UTRAN) and more particular to a method, a device and a system employing a Paging Indicator Channel (PICH) for signaling High-Speed Downlink Packet Access (HSDPA) for Time Division Duplex (TDD) mode. The structure of Paging Indicator Channel (PICH) is modified to enable a transmission of a High-Speed Indicator (HI) to a certain addressed mobile terminal device initiating the High-Speed Downlink Packet Access (HSDPA).

The present invention related to a method, a device and a system for High-Speed Downlink Packet Access (HSDPA) for Time Division Duplex (TDD) mode of a wireless communication system, especially of a Universal Mobile Telecommunication System (UMTS) Terrestrial Radio Access Network (UTRAN). More particular, the present invention relates to a method, a device and a system employing a Paging Indicator Channel (PICH) for signaling High-Speed Downlink Packet Access (HSDPA) for Time Division Duplex (TDD) mode.

The 3^{rd} Generation Partnership Project (3GPP) currently discusses methods for downlink signaling of Universal Mobile Telecommunication System (UMTS) Terrestrial radio access network (UTRAN) High-Speed Downlink Packet Access (HSDPA) for Time Division Duplex (TDD) mode.

For dedicated (transport) Channel (DCH) associated two-step signaling, the associated dedicated channel (DCH) and High-Speed Shared Control Channel (HS-SCCH) are needed for each mobile terminal device employing high-speed downlink services to transmit downlink signaling information. The Dedicated Channel (DCH) carries High-Speed Indicator (HI) bits used to indicate or designate a mobile terminal device to receive downlink signaling information on the High-Speed Shared Control Channel (HS-SCCH). This High-Speed Shared Control Channel (HS-SCCH) carries data comprising a mobile terminal device identification (UE ID), Transport Format Resource Indicator (TFRI), Hybrid Automatic Repeat Request (HARQ) mode and further signaling information for the mobile terminal device. These signaling information carried on the High-Speed Shared Control Channel (HS-SCCH) may be employed for receiving and decoding the packet data transmitted through the Downlink Shared Channel (DSCH).

This method for signaling High-Speed Downlink Packet Access (HSDPA) for Time Division Duplex (TDD) mode includes several disadvantages.

Each mobile terminal device employing High-Speed Downlink Packet Access (HSDPA) should have one associated Dedicated Channel (DCH) to transmit High-Speed Indicator (HI) bits. The number of Dedicated Channel (DCH) supported by the system will be matching the number of mobile terminal devices employing High-Speed Downlink Packet Access (HSDPA). Since these associated Dedicated Channels (DCH) are exclusively involved to carry High-Speed Indicator (HI) information comprising a few single bits (for example one or two bits) resources are not efficiently used and overall performance is wasted.

Further, the associated Dedicated Channel (DCH) is shared in the time domain upon the mobile terminal devices employing High-Speed Downlink Packet Access (HSDPA). A packet scheduler controlling the sequence in time of the associated Dedicated Channel (DCH) may have to be rescheduled if a mobile terminal device employing High-Speed Downlink Packet Access (HSDPA) exits and/or accesses the network for sharing the Dedicated Channel (DCH) in the time domain in Time Division Duplex (TDD) mode. The rescheduling is time consuming and lacks of flexibility in case of fast changing conditions, particularly in case of a high number of exiting mobile terminal devices employing High-Speed Downlink Packet Access (HSDPA).

The present invention offers a new approach for sending High-Speed Indicator (HI) information in the downlink signaling of High-Speed Downlink Packet Access (HSDPA) for Time Division Duplex (TDD) mode, particular for Universal Mobile Telecommunication System (UMTS) Terrestrial radio access network (UTRAN). The present invention aims to overcome the above described disadvantages of the method of state of the art. The basic idea of the present invention resides in that reserved and currently unused bits on the Paging Indicator Channel (PICH) are used to transmit High-Speed Indicator (HI) information to indicate a mobile terminal device to receive and decode signaling information on the High-Speed Shared Control Channel (HS-SCCH).

The usage of the Paging Indicator Channel (PICH) and the reserved bits thereon offers the possibility to establish a High-Speed Downlink Packet Access (HSDPA) without involving associated the Dedicated Channel (DCH) for each mobile terminal device employing the access service and thus saving Dedicated Channel (DCH) resources. Further, the implementation of a scheduler controlling the High-Speed Downlink Packet Access (HSDPA) and signaling thereof may be easier. Different coding of the reserved bits of the Paging Indicator Channel (PICH) used for signaling may offer additional flexibility since the coding may allow different mapping with respect to the configuration of the system. Moreover, the Paging Indicator Channel (PICH) is transmitted with high power. The high power transmission ensures that all mobile terminal devices within a cell may receive an adequate signal for decoding.

According to a first aspect of the present invention, a High-Speed Downlink Packet Access (HSDPA) for Time Division Duplex (TDD) mode of a wireless communication system, preferably of a Universal Mobile Telecommunication System (UMTS) and more preferably of a Universal Mobile Telecommunication System (UMTS) Terrestrial Radio Access Network (UTRAN) based on the usage of a Paging Indicator Channel is provided. The sender, i.e. a base station (node B) first sends indication information to a mobile terminal device (UE). The mobile terminal device (UE) identified by the said indication information further receives signaling information. Said mobile terminal device then, based on said signaling information, decodes packet data information. The invention is characterized by including a High-Speed Indicator (HI) into the slot structure of the Paging Indicator Channel (PICH). Therefore, the High-Speed Indicator (HI) comprises a plurality of identification bits. The identification bits are assigned to certain values.

The High-Speed Indicator (HI) is used to determine a specific mobile terminal device out of a plurality of mobile terminal devices. The mobile terminal device may be a participant of the corresponding mobile communication network and the High-Speed Downlink Packet Access (HSDPA) service provided by a sender. The sender may be a Base Station (BS) of a Universal Mobile Telecommunication System (IMTS), preferably a Node B Base Station (BS). The determined mobile terminal device is accessible in a downlink channel.

Conveniently, the High-Speed Indicator (HI) comprising identification bits may define an identification address. The address may be coded in different ways.

Preferably, the plurality of identification bits are four identification bits. The identification bits may be arranged adjacent to a midamble of the Paging Indicator Channel according to the slot structure thereof. The identification bits may be in groups in two pairs each comprising two bits. The pairs are arranged on either side of the midamble.

Additionally, a plurality of mobile terminal devices may be divided upon a plurality groups and assigned thereto. Each group may comprise several mobile terminal devices. The dividing of the mobile terminal devices upon several groups may be dynamical which means that mobile terminal devices may exit and/or access a group. The dividing upon groups may be rearranged according to certain operational conditions.

Preferably, each group may have assigned periods of time. Within the assigned periods of time certain services may be offered to the mobile terminal devices of the group and these mobile terminal devices may have to listen on certain channels in order to be able to receive information and/or data which are destined to one or more mobile terminal devices of the group. Mobile terminal devices of the remaining groups do not have to listen to the corresponding channels since the services are provided to the first mobile terminal devices.

The assigning of the groups to certain periods of time may instruct the mobile terminal devices of the groups only to listen, receive and decode information transmitted on the Paging Indicator Channel (PICH) within the assigned periods. Further, the assigning of the groups to certain periods of time may Instruct the mobile terminal devices of the groups only to listen, receive and decode information transmitted on the High-Speed Shared Control Channel (HS-SCCH) within the assigned periods of time and/or the assigning of the groups to certain periods of time may instruct the mobile terminal devices of the groups only to listen, receive and decode information transmitted on the Downlink Shared Channel (DSCH) within the assigned periods of time.

An address coded in the High-Speed Indicator using the identification bits may be used to code an address of the mobile terminal device which is preferably unique within a group. Addresses of mobile terminal devices assigned to different groups may be equal.

The periods of time assigned to a group may be periodical. Correspondingly, a repetition time may be assigned to each group and may define the respective periods of time for the groups. The repetition time of the groups may vary analog to the periods of time described above. The repetition time may be a static repetition time or a dynamic repetition time. The dynamic repetition time may be adapted to traffic load. A static repetition time may be assigned to each group while dividing the plurality of mobile terminal devices upon the plurality of groups. Further, accessing and exiting mobile terminal devices of the groups may make an adaptation of the repetition time necessary.

A mobile terminal device may receive information on the Paging Indicator Channel (PICH) including said identification bits. The receiving of identification bits included in the Paging Indicator Channel (PICH) may indicate a following transmission of high-speed downlink packets. The identification bits representing an address of a mobile terminal device may have to match to an address assigned to a mobile terminal device, wherein the address of the mobile terminal device may be coded according to the coding of the address with respect to the identification bits.

A mobile terminal device may receive signaling information on a High-Speed Shared Control Channel (HS-SCCH). Preferably, the mobile terminal device may also receive a High-Speed Indicator (HI) on the Paging Indicator Channel (PICH) and the High-Speed Indicator (HI) comprises an address coded by the identification bits, determining the receiving mobile terminal device.

More preferably, the High-Speed Indicator (HI) comprises an address determining a mobile terminal device and instructing this mobile terminal device to receive and decode signaling information transmitted on a High-Speed Shared Control Channel (HS-SCCH).

Additionally, the High-Speed Shared Control Channel (HS-SCCH) may comprise mobile terminal device identification (user identification or UE ID), Transport Format and Resource related Information (TFRI), Hybrid Automatic Repeat Request (HARQ) information, Uplink Synchronization information and Transport Power Control (TPC) information.

A mobile terminal device may receive and decode data packets on a Downlink Shared Channel (DSCH). The signaling information received on the High-Speed Shared Control Channel HS-SCCH) before may be employed for receiving and decoding of the data packets. Especially the transmission related information comprised in the signaling information transmitted on a High-Speed Shared Control Channel (HS-SCCH) may be employed for decoding.

The mobile terminal device may transmit a transmission related information. Preferably, the mobile terminal device may transmit transmission related information on a High-Speed Information Channel (HICH). The transmission related information may comprise an acknowledgement/non acknowledgement (ACK/NAK) indicating if the transmission on the Downlink Shared Channel (DSCH) may have been received and decoded correctly or erroneously. Further, the transmission related information may also comprise a quality indicator and a Transport Power Control (TPC).

The identification bits may be used to code an address of a mobile terminal device, preferably of a mobile terminal device within a group.

Preferably, the address coding may be based on a binary coding. Since four identification bits may be reserved for coding the address the binary coding may enable to code 2⁴=16 different addresses. Certain addresses, such as 0000₂ and 1111₂ may be dedicated to special functions, wherein the index 2 may denote the binary coding. For example, the address 0000₂ may indicate that no mobile terminal device is addressed and the address 1111₂ may indicate that all mobile terminal devices are addressed. Each mobile terminal device of a group may have assigned a unique address.

Moreover, the address coding may be based on a logic coding. Each bit may be assigned to a corresponding mobile terminal device. Since a bit may represent two different states the logic one state, e.g. the state “1” may indicate that the corresponding mobile terminal device is addressed whereas the state “0” may indicate that the corresponding mobile terminal device is not addressed. Address coding may enable to address a selection of mobile terminal devices at the same time. The four identification bits may allow to address four mobile terminal devices according to the logic address coding.

The grouping of the mobile terminal devices into different groups may be based on the data traffic generated by the mobile terminal devices. Further, the grouping of the mobile terminal devices into different groups may be based on N channel Hybrid Automatic Repeat Request (HARQ) scheme.

According to a second aspect of the present invention, a computer program for carrying out the method for High-Speed Downlink Packet Access (HSDPA) for Time Division Duplex (TDD) mode of a wireless communication system is provided, which comprises program code means for performing all of the steps of the preceding method description when the program is run on a computer, a network device, a mobile terminal device or an application specific integrated circuit.

According to a third aspect of the present invention, a computer program product is provided comprising program code means stored on a computer readable medium for carrying out the method for High-Speed Downlink Packet Access (HSDPA) for Time Division Duplex (TDD) mode of a wireless communication system of the preceding description, when the computer program product is run on a computer, a network device, a mobile terminal device or an application specific integrated circuit.

According to a fourth aspect of the present invention, a mobile terminal device for the High-Speed Downlink Packet Access (HSDPA) for Time Division Duplex (TDD) mode of a wireless communication system is provided, which is adapted to perform a method for the High-Speed Downlink Packet Access (HSDPA) for Time Division Duplex (TDD) mode of a wireless communication system as described in the aforementioned description. The mobile terminal device can be a computer, a network device or a mobile terminal device such as a mobile phone.

Preferably, the mobile terminal device may comprise means for decoding information transmitted on the Paging Indicator Channel (PICH) which enables to extract the included identification bits determining a specific mobile terminal device. An address corresponding to the coding of the identification bits may be assigned to the mobile terminal device. The address coding is described above in detail. In case of matching received signaling information transmitted on a High-Speed Shared Control Channel (HS-SCCH) may be employed to receive and decode data packet on a Downlink Shared Channel (DSCH).

The mobile terminal device may be assigned to a certain group according to the above described dividing of a plurality of mobile terminal devices upon a plurality of groups.

According to a fifth aspect of the present invention, a wireless communication system for the High-Speed Downlink Packet Access (HSDPA) for Time Division Duplex (TDD) mode is provided, which is adapted to perform a method for the High-Speed Downlink Packet Access (HSDPA) for Time Division Duplex (TDD) mode of a wireless communication system as described in the aforementioned description.

The wireless communication system may comprise a plurality of mobile terminal devices for the High-Speed Downlink Packet Access (HSDPA) for Time Division Duplex (TDD) mode described above in detail. Further a sender comprised by the wireless communication system may generate a signal according to the signal structure of the Paging Indicator Channel (PICH) comprising identification bits using an adequate generating means. The identification bits may be a High-Speed Indicator (HI) determining a specific one of the plurality of mobile terminal devices. The Paging Indicator Channel (PICH) may be transmitted to a plurality of mobile terminal devices. The plurality of mobile terminal devices may be grouped according to the aforementioned grouping procedure.

Moreover, the wireless communication system may also provide and transmit signaling information on a High-Speed Shared Control Channel (HS-SCCH) and/or data packets on a Downlink Shared Channel (DSCH). Corresponding means for generating and transmitting of corresponding radio signals may preferably provided by a sender of the mobile communication system.

Additionally, the sender may also provide means to divide or group a plurality of mobile terminal devices, respectively, to assign addresses according to the coding of the identification bits of the High-Speed Indicator and to assign periods of time for accessing for the grouped mobile terminal devices to the mobile communication network. The means for dividing or grouping, respectively and for assigning addresses and periods of time may be operated according to the above described operational procedures for dividing or grouping, respectively and for assigning addresses and periods of time.

In the following, the invention will be described in detail by referring to the enclosed drawing in which:

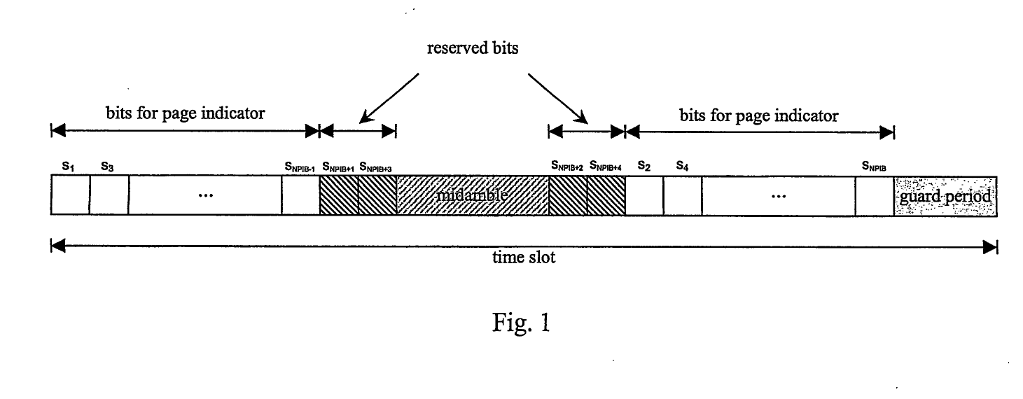

FIG. 1 shows a slot structure of a Paging Indicator Channel (PICH) according to an embodiment of the invention.

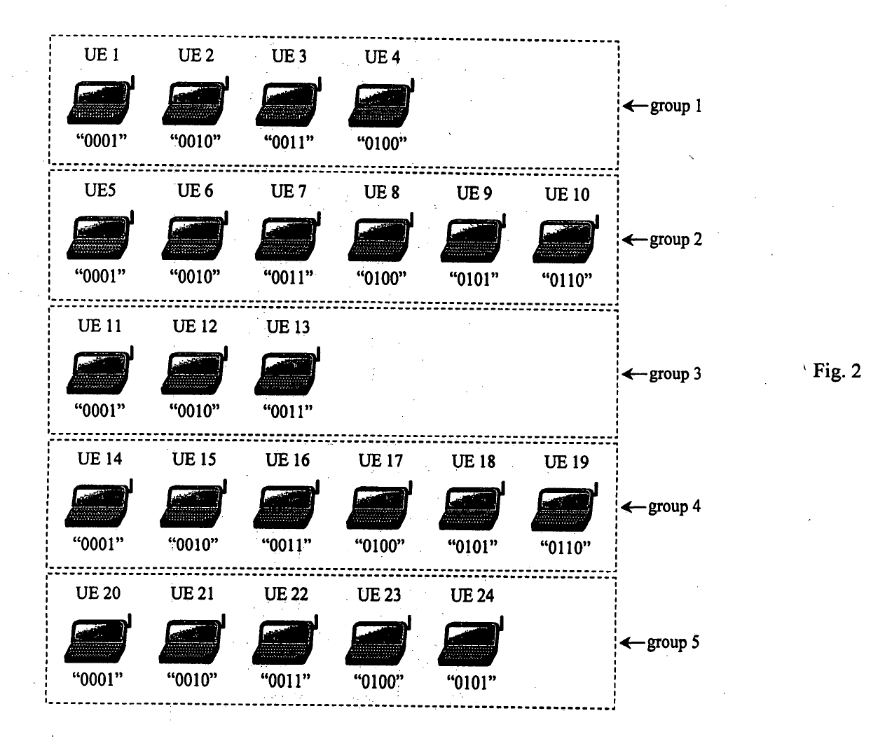

FIG. 2 shows a grouping of a plurality of mobile communication terminals according to an embodiment of the invention.

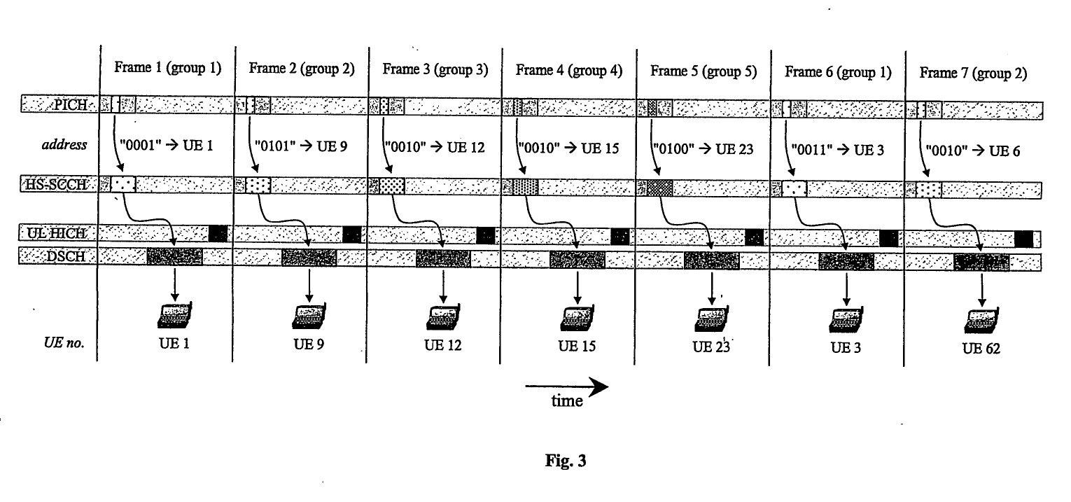

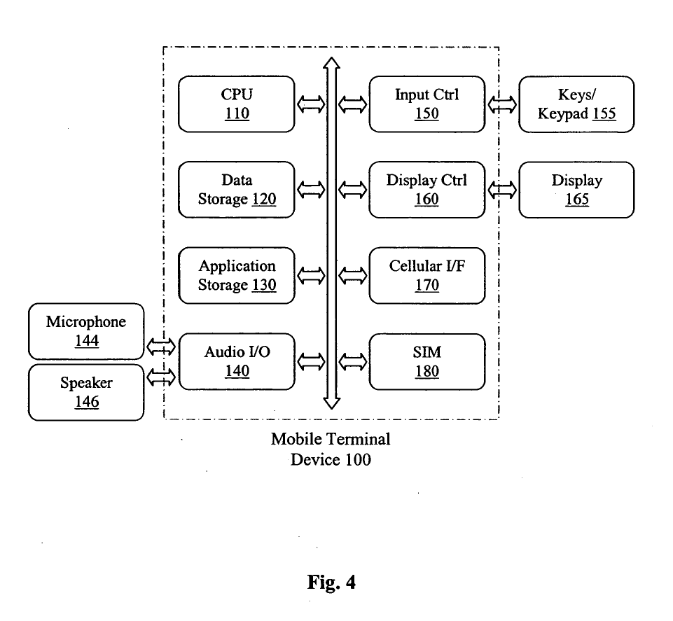

FIG. 3 shows frame diagram of a high data transmitting situation according to an embodiment of the invention.

FIG. 1 shows a slot structure of a Paging Indicator Channel (PICH) according to an embodiment of the invention. The shown slot structure depicts a Paging Indicator Channel (PICH) burst with respect to the 3GPP (3^{rd} Generation Partnership Project) and the number of bits and their arrangement within the burst structure.

The communication of data via a time duplex division (TDD) radio frequency communication system between a plurality of communication members such as base stations and mobile communication terminal is based on time slotted transmission structure within the time domain whereupon the certain periods of time are dedicated and assigned for the communication of a certain member of the time duplex division (TDD) radio frequency communication system. According to a standard defined by the 3GPP (3^{rd} Generation Partnership Project) a time duplex division (TDD) radio communication system, especially time duplex division (TDD) based universal mobile telecommunication services terrestrial radio access network (UTRAN), the time structure of a time duplex division radio communication network may be described by radio frames and time slots, wherein each radio frame comprises a plurality of time slots. According to the 3GPP standard definition each time division multiple access (TDMA) frame has duration of 10 ms and is subdivided into fifteen time slots (TS), whereas each time slot may be further subdivided into 2560.

The time slots may be allocated to either an uplink or a downlink transmission between a mobile terminal device and a base station. The time slot may be allocated completely to one of the transmission direction so that a frame may comprise an arbitrary sequence of uplink and downlink transmissions. The 2560 chips of a time slot may be primarily used for coding or spreading the communicated data within a time slot, respectively. The spreading of communicated data within a time slot is out of the scope of this invention and known to those skilled in the art and described in available standard documents of the 3^{rd} Generation Partnership Project (3GPP).

A burst of data may be designated as a physical channel of a time division duplex radio communication system. A burst may be transmitted in a time slot within an allocated frame and its duration is one time slot. Each burst may include a first data part, a midamble, a second data part and a guard part. Different type of burst may be available for data communication, particularly a type 1, type 2 and type 3, wherein the both burst types 1 and 2 may be employed for uplink and downlink data communication whereas burst type 3 may be employed exclusively for uplink data transmission. Type 2 burst may be distinguished by a larger data amount in comparison with type 1 burst. At maximum, a type 1 burst may comprise 1952 symbols of data (or bits, respectively) at spread factor 1 (SF 1) whereas a type 2 burst may comprise 2208 symbols of data (or bits, respectively) at spread factor 1. Correspondingly, at a spread factor 16 (SF 16) the burst may comprise 122 or 138 symbols of data, respectively.

The midamble may comprise training sequences. Since the total length of a burst may be defined by a time slot the training sequence or midamble of a type 1 burst comprises a training sequence of more data symbols than a type 2 burst. The guard period of both the type 1 and type 2 burst may comprise the same number of data symbols.

The Paging Indicator Channel (PICH) indicates or designates a mobile terminal device for which it is provided that a Paging Message might be accepted thereby on the Paging Channel (PCH). The mobile terminal devices may be assigned to a paging group when it is registered with the network. These paging groups may be indicated by the use of Paging Indicators (PI) carried on the Paging Indicator Channel (PICH).

Two different burst types, type 1 and type 2, are employed for defining different numbers of bits N_{pib} or number of data symbols within the structure, respectively. The burst type 1 may carry a Paging Indicator (PI) with a number of bits N_{pib}=240, whereas the burst type 2 may carry another Paging Indicator (PI) with a number of bits N_{pib}=272. The bits s_{NPIB+1}, . . . , s_{NPIB+4} adjacent to the midamble are reserved up to now for future usage. The usage of the remaining bits s₁, . . . , s_{NPIB} are defined by the 3GPP standard.

These four reserved bits s_{NPIB+1}, . . . , s_{NPIB+4} may be used for addressing an individual mobile terminal device out of a group of mobile terminal devices and indicating to the mobile terminal device to receive a high-speed downlink packet. Therefore, the four reserved bits may be designated in the following description as an address or a High-Speed Indicator (HI). Two different coding may be employed for enabling an addressing of a mobile terminal device.

A first address coding may be based on a binary coding of an individual address of each mobile terminal device out of the group of mobile terminal devices. The first address coding may be based on a binary coding of the addresses. This coding method may be employed in case of one device which may be allowed to transmit high-speed downlink packets in each frame. The employed four bits for coding an individual address of a mobile terminal device may allow to assign 2⁴=16 different addresses for addressing. In the following binary coded numbers and hence also the binary coded addresses may be indicated by a subscript “2”, whereas the respective decimal spelling is indicated by a subscript “10”. In the following description of this invention the states of the four bits may be denoted enclosed within quotation marks, such as “0010”.

The addresses 0000₂=0₁₀, 1111₂=15₁₀ may be reserved for special addressing operations and not assigned to any certain mobile terminal device. The address 0000₂=0₁₀ may indicate that no one of the mobile terminal devices of the group thereof may is addressed, whereas the address 1111₂=15₁₀ may indicate that all mobile terminal devices of the group thereof may be addressed.

Thus, fourteen remaining addresses may be used for addressing individual mobile terminal devices when the both addresses 0000₂=0₁₀, 1111₂=15₁₀ may be employed for the above described special operations. The remaining addresses 0001₂=1₁₀, 0010₂=2₁₀, 0011₂=3₁₀, . . . , 1110₂=14₁₀ may allow to address maximum fourteen different mobile terminal devices and may be assigned correspondingly thereto.

A second address coding may be based on a non binary coding of addresses. Each bit of the reserved four identification bits may be assigned to a certain mobile terminal device for addressing. This coding method may be employed advantageously in case of several devices which may be allowed to transmit high-speed packet data in each frame. Therefore, it may be possible to address four different mobile terminal devices and hence, the group of mobile terminal devices may comprise maximal four different mobile terminal devices. Each bit may offer two different bits states, a bit state “1” and a bit state “0”, respectively.

The address “1000” may indicate that, for example, the first mobile terminal device out of the group of the four mobile terminal devices may be addressed, whereas the remaining three mobile terminal devices (second, third and fourth) may be not addressed. Correspondingly further, the address “0100” may indicate that, for example, the second mobile terminal device out of the group of the four mobile terminal devices may be addressed, whereas the remaining three mobile terminal devices (first, third and fourth) may be not addressed. Correspondingly further, the address “0010” may indicate that, for example, the third mobile terminal device out of the group of the four mobile terminal devices may be addressed, whereas the remaining three mobile terminal devices (first, second and fourth) may be not addressed. Correspondingly further, the address “0001” may indicate that, for example, the fourth mobile terminal device out of the group of the four mobile terminal devices may be addressed, whereas the remaining three mobile terminal devices (first, second and third) may be not addressed.

This second address coding allows to address a selected subgroup out of the group of four mobile terminal devices. For example, the address coding “1001” may indicate that, for example, the first and fourth mobile terminal devices are addressed whereas the second and the third mobile terminal devices are not addressed. For example, the address coding “1011” may indicate that, for example, the first, third and fourth mobile terminal devices are addressed whereas the second mobile terminal device is not addressed.

The usage and functionality connected to the addresses “0000” and “1111” is the same like described in combination with the first address coding procedure. A coded address “0000” may indicate that no one of the mobile terminal devices is addressed to initiate a data transmission. Correspondingly, an address “1111” may indicate an initialization of a data transmission to all four mobile terminal devices of the group.

In the following description, the address coding of the mobile terminal devices may be based on the first address coding mentioned and described above. The below presented description may be employed in a similar manner in combination with the above mentioned second address coding.

FIG. 2 shows a grouping of a plurality of mobile communication terminal according to an embodiment of the invention. A plurality of mobile terminal devices is shown in FIG. 2. The mobile terminal devices are grouped in five separate groups each comprising a subset of plurality of mobile terminal devices. The grouping and the number of mobile terminal devices within the different groups is exemplary and the grouping may performed in another arrangement. Since the address coding is based on the first address coding procedure the different groups may comprise maximal fourteen mobile terminal devices. Further, the number of groups may also be exemplary and not limited to the depicted five different groups.

A first group designated as group 1 may comprise exemplary four mobile terminal devices and the mobile terminal devices may be designated as UE 1, UE 2, UE 3 and UE 4, respectively. According to the address coding procedure, the addresses “0001”, “0010”, “0011” and “0100” may be assigned to the corresponding mobile terminal devices UE 1, UE 2, UE 3 and UE 4.

A second group designated as group 2 may comprise exemplary six mobile terminal devices and the mobile terminal devices may be designated as UE 5, UE 6, UE 7, UE 8, UE 9 and UE 10, respectively. According to the address coding procedure, the addresses “0001”, “0010”, “0011” “0100” “0101” and “0110” may be assigned to the corresponding mobile terminal devices UE 5, UE 6, UE 7, UE 8, UE 9 and UE 10.

A third group designated as group 3 may comprise exemplary three mobile terminal devices and the mobile terminal devices may be designated as UE 11, UE 12 and UE 13, respectively. According to the address coding procedure, the addresses “0001”, “0010” and “0011” may be assigned to the corresponding mobile terminal devices UE 11, UE 12 and UE 13.

A fourth group designated as group 4 may comprise exemplary six mobile terminal devices and the mobile terminal devices may be designated as UE 14, UE 15, UE 16, UE 17, UE 18 and UE 19, respectively. According to the address coding procedure, the addresses “0001”, “0010”, “0011” “0100” “0101” and “0111” may be assigned to the corresponding mobile terminal devices UE 14, UE 15, UE 16, UE 17, UE 18 and UE 19.

A fifth group designated as group 5 may comprise exemplary four mobile terminal devices and the mobile terminal devices may be designated as UE 20, UE 21, UE 22, UE 23 and UE 24, respectively. According to the address coding procedure, the addresses “0001”, “0010”, “0011”, “0100” and “0101” may be assigned to the corresponding mobile terminal devices UE 20, UE 21, UE 22, UE 23 and UE 24.

The plurality of mobile terminal devices are divided into a plurality groups. The number of groups may and the division thereupon may be performed dynamically or statically. For example, the grouping (arrangement and/or number of groups) may be based on traffic load or N channel Hybrid Automatic Repeat Request (HARQ) scheme.

The following FIG. 3 may represent a time flow diagram according to an embodiment of the method of the present invention. The time flow diagram is based on the grouping presented above according to FIG. 2.

FIG. 3 shows frame diagram of a high data transmitting situation according to an embodiment of the invention. The five groups each comprising mobile terminal devices, shown in FIG. 2 may listen to the Paging Indicator Channel (PICH). According to this embodiment of the invention, the mobile terminal devices of one group may listen to the Paging Indicator Channel (PICH) every fifth frame. Correspondingly, group 1 may listen to frame 1, group 2 to frame 2, group 3 to frame 3, group 4 to frame 4 and group 5 to frame 5. Beginning with frame 6 group 1 may listen again thereto and further group 2 may follow in listening to frame 7. This sequencing of the groups may be continued. Analog to the grouping of the mobile terminal devices, the period of repetition may be defined both dynamically or statically. For example, the period of repetition may be based on traffic load or N channel Hybrid Automatic Repeat Request (HARQ) scheme. Further, the groups may have the same periods of repetition.

The following channels may be involved in and used by the embodiment of the present invention. A short describing introduction of the channels will be given since the complete definition of the respective channels may be known to those skilled in the art.

The Paging Indicator Channel (PICH) may indicate to a mobile terminal device that a Paging Message might be expected thereby on the Paging Channel (PCH). The mobile terminal devices may be assigned to a paging group when it is registered with the network. These paging groups may be indicated by the use of Paging Indicators (PI) carried on the Paging Indicator Channel (PICH). Here in the invention, the reserved bits as in FIG. 1 are used as High Speed Indicator (HI) which comprise the coded address of a mobile terminal device of the respective group for initialing a high-speed downlink transmission.

The High-Speed Shared Control Channel (HS-SCCH) may be used to carry indicator and signaling information to be employed for receiving and decoding information transmitted through a Downlink Shared Channel (DSCH).

The Downlink Shared Channel (DSCH) is used to carry dedicated user data or control signal to one or more mobile terminal devices in a communication cell. The decoding of the dedicated user data or control signal may be enabled and controlled by information transmitted via the above mentioned High-Speed Shared Control Channel (HS-SCCH).

The Uplink High-Speed Downlink Packet Access (HSDPA) Information Channel UL-HICH) may be used to carry indicator and signaling information to a base station or Node B, respectively. Three different fields may be comprised, an acknowledge/negative acknowledge (ACK/NAK) field, a Quality Indicator field and a Transmit Power Control (TPC) field.

Each mobile terminal device of a corresponding group according to a specific frame assigned to the corresponding group may listen to the Paging Indicator Channel (PICH) of this frame while the mobile terminal device of the other groups do not listen. Further, the mobile terminal device of this group may share the Downlink Shared Channel (DSCH).

In the following, the time sequence provided in FIG. 3 will be described with respect to each single frame.

In a frame 1, all mobile terminal devices comprised by the group 1 may listen to the Paging Indicator Channel (PICH). An address of a mobile terminal device out of group 1 may be comprised in the high speed indicator (HI) carried by the Paging Indicator Channel (PICH) and received by the mobile terminal devices of group 1. The address “0001” may be coded in the High speed indicator (HI) according to the above described first coding procedure (shown in FIG. 1). The mobile terminal device UE 1 which may have been assigned the address “0001” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report. Preferably the confirmation may be transmitted via the Uplink High-Speed Downlink Packet Access (HSDPA) Information Channel (UL-HICH) carrying the above described information.

The operations of the following frames are carried out analog to the operations described with respect to frame 1.

In a frame 2, the mobile terminal devices of group 2 may listen to the Paging Indicator Channel (PICH) which may transmit an address of a mobile terminal device “0101” corresponding to mobile terminal device UE 9 of group 2. The mobile terminal device UE 9 which may have been assigned the address “0101” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) Information Channel (UL-HICH).

In a frame 3, the mobile terminal devices of group 3 may listen to the Paging Indicator Channel (PICH) which may transmit an address of a mobile terminal device “0010” corresponding to mobile terminal device UE 12 of group 3. The mobile terminal device UE 12 which may have been assigned the address “0010” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) information Channel (UL-HICH).

In a frame 4, the mobile terminal devices of group 4 may listen to the Paging Indicator Channel (PICH) which may transmit an address of a mobile terminal device “0010” corresponding to mobile terminal device UE 15 of group 4. The mobile terminal device UE 15 which may have been assigned the address “0010” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A conformation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) Information Channel (UL-HICH).

In a frame 5, the mobile terminal devices of group 5 may listen to the Paging Indicator Channel (PICH) which may transmit an address of a mobile terminal device “0100” corresponding to mobile terminal device UE 23 of group 5. The mobile terminal device UE 23 which may have been assigned the address “0100” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) Information Channel (UL-HICH).

In a frame 6, the mobile terminal devices of group 1 may listen to the Paging Indicator Channel (PICH) which may transmit an address of a mobile terminal device “0011” corresponding to mobile terminal device UE 3 of group 1. The mobile terminal device UE 3 which may have been assigned the address “0011” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) Information Channel (UL-HICH).

In a frame 7, the mobile terminal devices of group 2 may listen to the Paging Indicator Channel RICH) which may transmit an address of a mobile terminal device “0010” corresponding to mobile terminal device UE 6 of group 2. The mobile terminal device UE 6 which may have been assigned the address “0010” decodes its address and hence may be indicated to receive and decode the downlink signaling information which may be transmitted through and obtained on the High-Speed Shared Control Channel (HS-SCCH). The downlink signaling information may enable the mobile terminal device to receive and decode the high-speed packet data in the Downlink Shared Channel (DSCH) by using this received and decoded downlink signaling information. A confirmation may be transmitted to the high-speed downlink packet sender, such as a Node B. The confirmation may comprise an acknowledge/negative acknowledge (ACK/NAK) and measurement report and preferably transmitted via the Uplink High-Speed Downlink Packet Access (HSDPA) Information Channel (UL-HICH).

This specification contains the description of implementations and embodiments of the present invention with the help of examples. It will be appreciated by a person skilled in the art, that the present invention is not restricted to details of the embodiments presented above, and that the invention can be also implemented in another form without deviating from the characteristics of the invention. The embodiment presented above should be considered as illustrative, but not restricting. Thus, the possibilities of implementing and using the invention are only restricted to the enclosed claims.

1. A method for High-Speed Downlink Packet Access signaling for Time Division Duplex mode of a wireless communication system, comprising the following steps:
a base station sending indication information to a mobile terminal device (UE);
the mobile terminal device (UE) identified by the said indication information receiving signaling information;
said mobile terminal device, based on the said signaling information, decoding packet data information;
wherein a High-Speed Indicator designates a specific mobile terminal device accessible in a downlink channel,
characterized by the steps of:
including said High-Speed Indicator into the slot structure of a Paging Indicator Channel (PICH), said High-Speed Indicator comprising a plurality of identification bits, each identification bit being assigned.

2. A method according to claim 1, wherein said plurality of identification bits are four identification bits arranged in two pairs each of two bits on either side of and adjacent to a midamble area of said Paging Indicator Channel (PICH).

3. A method according to any one of the preceding claims claim 1, comprising the following further step:
dividing a plurality of mobile terminal devices upon a plurality of groups.

4. A method according to claim 3, comprising the following further step:
assigning certain periods of time to each group,
wherein each mobile terminal device of a group receives data transmitted within said periods of time assigned to said respective group via said Paging Indicator Channel (PICH).

5. A method according to claim 3, comprising the following further step:
assigning a High-Speed Indicator to each mobile terminal device of a group.

6. A method according to claim 4, wherein said periods of time of a group are assigned according to the data traffic of the group.

7. A method according to claim 1, comprising the following further step:
receiving information on said Paging Indicator Channel (PICH) by a mobile terminal device.

8. A method according to claim 1, comprising the following further step:
receiving signaling information on a High-Speed Shared Control Channel (HS-SCCH) by a mobile terminal device.

9. A method according to claim 7, comprising the following further step:
receiving and decoding data packets on a Downlink Shared Channel (DSCH) by a mobile terminal device,
wherein the receiving and decoding step employs said signaling information received on said High-Speed Shared Control Channel (HS-SCCH).

10. A method according to claim 1, comprising the following further step:
transmitting transmission related information.

11. A method according to claim 1, wherein said identification bits code a binary address of a mobile terminal device.

12. A method according to claim 1, wherein said identification bits code a logical address of a mobile terminal device.

13. A method according to claim 3, wherein said dividing a plurality of mobile terminal devices upon a plurality of groups is based on the data traffic.

14. A method according to claim 3, wherein said dividing a plurality of mobile terminal devices upon a plurality of groups is based on an N channel Hybrid Automatic Repeat Request scheme.

15. A computer program for executing a method for High-Speed Downlink Packet Access for Time Division Duplex mode of a wireless communication system, comprising program code means for carrying out each of the steps of claim 1 when said program is run on a computer, a network device, a mobile device, or an application specific integrated circuit.

16. A computer program product comprising program code means stored on a computer readable medium for carrying out each of the steps of the method for High-Speed Downlink Packet Access for Time Division Duplex mode of a wireless communication system of claim 1 when said program product is run on a computer, a network device, a mobile device, or an application specific integrated circuit.

17. A mobile terminal device for High-Speed Downlink Packet Access for Time Division Duplex mode of a wireless communication system, comprising means adapted to perform each of the steps of the method for High-Speed Downlink Packet Access for Time Division Duplex mode of a wireless communication system according to claim 1.

18. A wireless communication system for High-Speed Downlink Packet Access for Time Division Duplex mode, comprising means adapted to perform a method for High-Speed Downlink Packet Access for Time Division Duplex mode of a wireless communication system according to claim 1.
